(19) United States
(12) Patent Application Publication
(10) Pub. No.: US 2025/0337123 A1
(43) Pub. Date: Oct. 30, 2025

(54) SOFT PACK BUTTON BATTERY MODULE, SOUND PRODUCTION APPARATUS, AND ELECTRONIC DEVICE

(71) Applicant: HUAQIN TECHNOLOGY CO., LTD., Shanghai (CN)

(72) Inventors: HENG YAO, Shanghai (CN); JIANZHONG HUANG, Shanghai (CN); PEINENG LI, Shanghai (CN); CHENGPING XIAO, Shanghai (CN)

(21) Appl. No.: 18/867,220

(22) PCT Filed: Oct. 14, 2022
(86) PCT No.: PCT/CN2022/125426

§ 371 Date: Nov. 19, 2024

(30) Foreign Application Priority Data
May 20, 2022 (CN) 202210556397.7

(51) Int. Cl. H01M 50/503; H01M 50/109; H01M 50/247; H01M 50/528; H04R 1/10

(52) U.S. Cl. CPC H01M 50/503; H01M 50/109; H01M 50/247; H01M 50/528; H04R 1/1025; H01M 2220/30

(57) ABSTRACT

A soft pack button battery module includes a soft pack button battery. A surface of the soft pack button battery is provided with an arc-shaped conductive sheet and a conductive sheet tab. The arc-shaped conductive sheet is connected to a first tab of the soft pack button battery, and extends from the first tab to the conductive sheet tab. The conductive sheet tab is spaced apart from a second tab of the soft pack button battery.

### BACKGROUND

### 1. Technical Field

The present application belongs to the technical field of button batteries, and in particular relates to a soft pack button battery, a sound production apparatus, and an electronic device.

### 2. Background of the Invention

A wireless electronic device is typically realized by a Bluetooth module and a button battery, which offers great convenience for a user to carry and use electronic products, in particular wireless earphones, and thus is very popular among users.

However, the Bluetooth module generates great instantaneous current when transmitting a signal, which may generate a magnetic field that directly interferes with an internal coil of the loudspeaker. In some electronic products, the battery volume is increased to extend a battery life, and therefore, the battery is placed closer to the loudspeaker, causing more severe interference and increased background noise, and impairing the sound production effect of the sound production apparatus.

### SUMMARY

The present application provides the following technical solutions:

The present application provides a soft pack button battery module, including: a soft pack button battery having a first tab and a second tab arranged opposite to each other: an arc-shaped conductive sheet connected to the first tab and extending towards the second tab: and a conductive sheet tab spaced apart from the second tab, where the arc-shaped conductive sheet extends from the first tab along a surface of the soft pack button battery to be connected to the conductive sheet tab.

The present application further provides a sound production apparatus, including: a loudspeaker and a soft pack button battery module as described above, where the loudspeaker is connected to the soft pack button battery module via a positive lead and a negative lead of the soft pack button battery module.

The present application further provides an electronic device, including: a device body, and a sound production apparatus as described above.

The soft pack button battery module, the sound production apparatus and the electronic device provided in the present application can bring about at least one of the following beneficial effects:

An arc-shaped conductive sheet and a conductive sheet tab are provided on a surface of the soft pack button battery, the arc-shaped conductive sheet is connected to a first tab of the soft pack button battery, and extends from the first tab to the conductive sheet tab, where the conductive sheet tab is spaced apart from a second tab of the soft pack button battery, so that by means of the arc-shaped conductive sheet and the conductive sheet tab, winding lengths of two electrodes of the soft pack button battery are compensated externally to enable a magnetic field generated by positive current and a magnetic field generated by negative current to be mutually counteracted, and reduce the overall strength of the magnetic field toward the outside. When applied to a sound production apparatus, the soft pack button battery module can help to increase isolation between the soft pack button battery module and a loudspeaker, alleviate interference of the soft pack button battery with the loudspeaker, reduce background noise, and improve the sound production effect of the sound production apparatus.

### BRIEF DESCRIPTION OF THE DRAWINGS

To explain the technical solutions in the embodiments of the present application more clearly, the drawings to be used in the description of the embodiments will be briefly described below. Apparently, the drawings in the following description are merely some embodiments of the present application, and other drawings may be derived from these drawings by those of ordinary skill in the art without any creative labor.

FIG. 1 is a schematic structural diagram of a soft pack button battery module according to some embodiments of the present application;

FIG. 2 is an enlarged view of area S in FIG. 1;

FIG. 3 is a schematic diagram showing connection between a soft pack button battery module and positive and negative leads according to some embodiments of the present application;

FIG. 4 is an exploded view of a soft pack button battery module according to some embodiments of the present application;

FIG. 5 is a schematic structural diagram of a sound production apparatus according to some embodiments of the present application;

FIG. 6 is a schematic structural diagram of an electronic device according to some embodiments of the present application;

FIG. 7 is a background noise test curve for earphones using a conventional soft pack button battery; and

FIG. 8 is a background noise test curve of earphones using a soft pack button battery module according to the present application.

### DETAILED DESCRIPTION OF THE INVENTION

An object of embodiments of the present application is to provide a soft pack button battery module, a sound production apparatus, and an electronic device which can enable a magnetic field generated by positive current and a magnetic field generated by negative current to be mutually counteracted, and reduce the overall strength of the magnetic field toward the outside, and when applied to a sound production apparatus, the soft pack button battery module can help to increase isolation between the soft pack button battery module and a loudspeaker, alleviate interference of the soft pack button battery with the loudspeaker, reduce background noise, and improve the sound production effect of the sound production apparatus.

An embodiment of the present application provides a soft pack button battery module, including: a soft pack button battery having a first tab and a second tab arranged opposite to each other; an arc-shaped conductive sheet connected to the first tab and extending towards the second tab; and a conductive sheet tab spaced apart from the second tab, where the arc-shaped conductive sheet extends from the first tab along a surface of the soft pack button battery to be connected to the conductive sheet tab. According to the soft pack button battery module provided in the present application, an arc-shaped conductive sheet and a conductive sheet tab are provided on a surface of the soft pack button battery, the arc-shaped conductive sheet is connected to a first tab of the soft pack button battery, and extends from the first tab to the conductive sheet tab, where the conductive sheet tab is spaced apart from a second tab of the soft pack button battery, so that by means of the arc-shaped conductive sheet and the conductive sheet tab, winding lengths of two electrodes of the soft pack button battery are compensated externally to enable a magnetic field generated by positive current and a magnetic field generated by negative current to be mutually counteracted, and reduce the overall strength of the magnetic field toward the outside, and when applied to a sound production apparatus, the soft pack button battery module can help to increase isolation between the soft pack button battery module and a loudspeaker, alleviate interference of the soft pack button battery with the loudspeaker, reduce background noise, and improve the sound production effect of the sound production apparatus.

To make the objects, technical solutions and advantages of some embodiments of the present application clearer, some embodiments of the present application will be described in detail below with reference to the accompanying drawings.

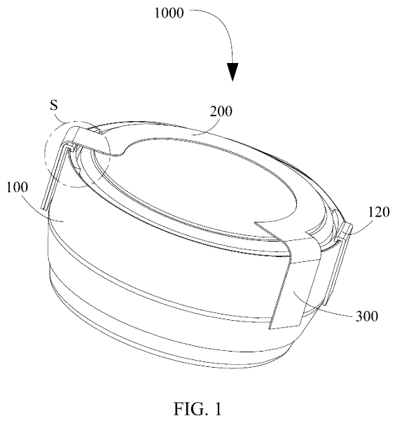

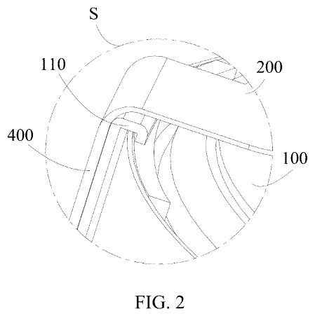

FIGS. 1 and 2 are schematic structural diagrams of a soft pack button battery module 1000 according to the present implementation, which includes: a soft pack button battery 100, an arc-shaped conductive sheet 200, and a conductive sheet tab 300. The soft pack button battery 100 has a first tab 110 and a second tab 120 arranged opposite to each other. The arc-shaped conductive sheet 200 is connected to the first tab 110 and extends towards the second tab 120. The conductive sheet tab 300 is spaced apart from the second tab 120, and the arc-shaped conductive sheet 200 extends from the first tab 110 along a surface of the soft pack button battery 100 to be connected to the conductive sheet tab 300.

Compared with the existing art, the soft pack button battery module provided in the embodiments of the present application is characterized in that an arc-shaped conductive sheet 200 and a conductive sheet tab 300 are provided on a surface of the soft pack button battery 100, the arc-shaped conductive sheet 200 is connected to a first tab 110 of the soft pack button battery 100, and extends from the first tab 110 to the conductive sheet tab 300, where the conductive sheet tab 300 is spaced apart from a second tab 120 of the soft pack button battery 100, so that by means of the arc-shaped conductive sheet 200 and the conductive sheet tab 300, winding lengths of two electrodes of the soft pack button battery 100 are compensated externally to enable a magnetic field generated by positive current and a magnetic field generated by negative current to be mutually counteracted, and reduce the overall strength of the magnetic field toward the outside, and when applied to a sound production apparatus, the soft pack button battery module 1000 can help to increase isolation between the soft pack button battery module 1000 and a loudspeaker, alleviate interference of the soft pack button battery 100 with the loudspeaker, reduce background noise, and improve the sound production effect of the sound production apparatus.

Optionally, the arc-shaped conductive sheet 200 may also have other shapes, for example, may be a multi-segment curved conductive sheet formed by multiple straight plate-like segments connected in sequence, and may have a circular arc shape, an elliptic arc shape or any other shape, as long as the conductive sheet can compensate for a difference in winding length of the electrodes inside the soft pack button battery 100, enable magnetic fields generated by positive and negative current of the soft pack button battery 100 to be mutually counteracted, and alleviate interference of the soft pack button battery 100 with the loudspeaker, which are not specifically limited in the embodiments of the present application.

It is to be understood that the arc-shaped conductive sheet 200 and the conductive sheet tab 300 may be integrally formed, so that a step of connecting the arc-shaped conductive sheet 200 and the conductive sheet tab 300 may be omitted.

In some embodiments, the first tab 110 is a positive tab 110, the second tab 120 is a negative tab 120, the soft pack button battery 100 is a cylinder with two opposite bottom surfaces, the positive tab 110 and the negative tab 120 are disposed on a side surface of the soft pack button battery 100, and the arc-shaped conductive sheet 200 extends to the conductive sheet tab 300 by conforming to either bottom surface of the soft pack button battery 100. By providing the arc-shaped conductive sheet 200 conforming to the bottom surface of the soft pack button battery 100, an extension length of the arc-shaped conductive sheet 200 can exceed half a circumference of the bottom surface, and the difference in winding length of the electrodes inside the soft pack button battery 100 can be better compensated, so that the magnetic field generated by positive current and the magnetic field generated by negative current can be better counteracted with each other, and the overall strength of the magnetic field toward the outside can be further reduced.

In other embodiments, the arc-shaped conductive sheet 200 extends to the conductive sheet tab 300 by conforming to the side surface of the soft pack button battery 100, so that a plate-like conductive sheet can be simply bent to form an arc-shaped conductive sheet 200 that conforms to a side wall radian of the soft pack button battery 100. In this manner, the manufacturing difficulty of the arc-shaped conductive sheet 100, and therefore the manufacturing difficulty and manufacturing cost of the soft pack button battery module 1000, can be reduced.

It is to be understood that in other embodiments, the first tab 110 may be referred to as a negative tab, and the second tab 120 may be referred to as a positive tab.

Referring again to FIG. 1, in some embodiments, the arc-shaped conductive sheet 200 extends into a circular arc along an edge of the bottom surface of the soft pack button battery 100, and is bent at an end of the circular arc and extends along the side surface of the soft pack button battery 100 to the conductive sheet tab 300. In this manner, by providing the arc-shaped conductive sheet 200 extending into a circular arc along the edge of the bottom surface, consistency between the extension length of the arc-shaped conductive sheet 200 and the difference in winding length of the electrodes inside the soft pack button battery 100 can be increased to improve the compensation, thereby further reducing the overall strength of the magnetic field of the soft pack button battery 100 toward the outside: and by providing the arc-shaped conductive sheet 200 bent at the end and extending along the side surface to the conductive sheet tab 300, the arc-shaped conductive sheet 200 can be tightly attached to the surface of the soft pack button battery 100, thereby enhancing the connection strength between the arc-shaped conductive sheet 200 and the soft pack button battery 100.

Optionally, the arc-shaped conductive sheet 200 extends into a circular arc of 100° to 250° (for example, 100°, 200° and 250°). In this range, the arc-shaped conductive sheet 200 can effectively compensate for the difference in winding length of the electrodes inside the soft pack button battery 100.

It is to be understood that when the arc-shaped conductive sheet 200 extends into a circular arc of a degree within a certain range, the conductive sheet tab 300 and the negative tab 120 are at least partially overlapped, which can be simply solved by disposing the conductive sheet tab 300 on a side of the negative tab 120 facing away from the side surface of the soft pack button battery 100, and then providing an insulation layer sandwiched between the conductive sheet tab 300 and the negative tab 120.

In some embodiments, the arc-shaped conductive sheet 200 is connected to the surface of the soft pack button battery 100 by gluing, which can ensure sufficient connection strength and stability of the arc-shaped conductive sheet 200, while reducing the assembly difficulty and cost of the soft pack button battery module 1000.

In some embodiments, the arc-shaped conductive sheet 200 is connected to the positive tab 110 by laser welding, so that due to the laser welding with low thermal input and free of electromagnetic field influence, deformation of the arc-shaped conductive sheet 200 and the positive tab 110 during the welding process can be reduced.

It is to be understood that the arc-shaped conductive sheet 200 may also be connected to the conductive sheet tab 300 by laser welding.

Optionally, the connection between the arc-shaped conductive sheet 200 and the positive tab 110, and the connection between the arc-shaped conductive sheet 200 and the conductive sheet tab 300, may also be implemented by other welding methods, or by snap-fit, as long as the arc-shaped conductive sheet 200 can be securely connected to the positive tab 110 and used normally, while the arc-shaped conductive sheet 200 is also securely connected to the conductive sheet tab 300 and used normally, which is not specifically limited in the embodiments of the present application.

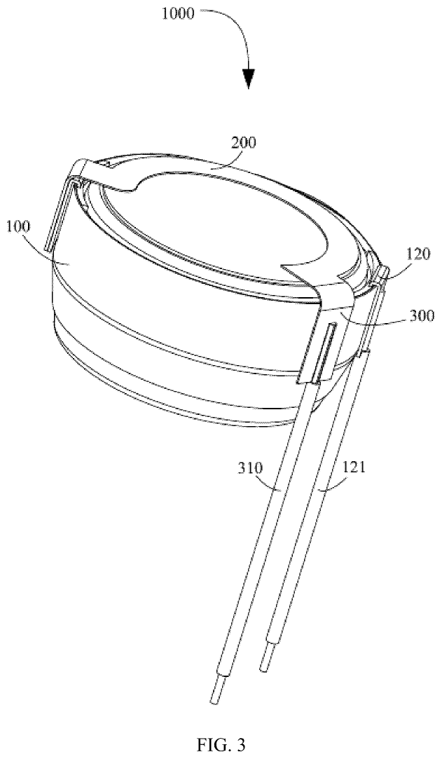

Also referring to FIG. 3, the soft pack button battery module 1000 further includes a positive lead 310 and a negative lead 121. The positive lead 310 is connected to the conductive sheet tab 300 by electric resistance welding, and the negative lead 121 is connected to the negative tab 120 by electric resistance welding. The electric resistance welding uses a welding voltage on the order of several volts, which can save energy, reduce generation of smoke and light, meet the environmental protection requirement, and improve the safety of welding.

Optionally, the connection between the conductive sheet tab 300 and the positive lead 310 may also be implemented by other welding methods, or by gluing, as long as the conductive sheet tab 300 can be securely connected to the positive lead 310, and the soft pack button battery module 1000 can function normally, which is not specifically limited in the embodiments of the present application.

Optionally, the arc-shaped conductive sheet 200 and the conductive sheet tab 300 in the above embodiments may be made of nickel, or may be made of other conductive materials, such as copper and aluminum, as long as the arc-shaped conductive sheet 200 and the conductive sheet tab 300 are conductive, and the soft pack button battery module 1000 can be used normally, which is not specifically limited in the embodiments of the present application.

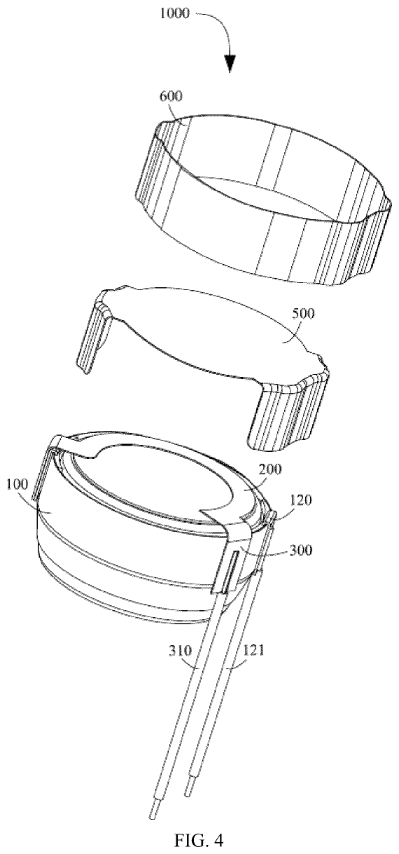

Also referring to FIG. 4, in some embodiments, the soft pack button battery module 1000 further includes a fixing shell 500 and a fixing ring 600. The fixing shell 500 is covered on a side of the arc-shaped conductive sheet 200 facing away from the soft pack button battery 100, and covers the positive lead 310 and the negative lead 121, to constrain the conductive sheet tab 300, the positive lead 310 and the negative lead 121, and further fix the conductive sheet tab 300, the positive lead 310 and the negative lead 121, while the fixing ring 600 is sleeved on a periphery of the fixing shell 500 to fix the fixing shell 500.

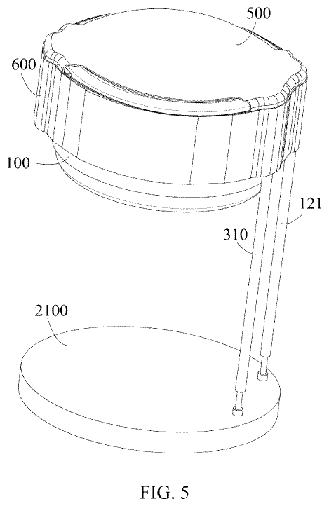

An embodiment of the present application further provides a sound production apparatus 2000 which, as shown in FIG. 5, includes: a loudspeaker 2100 and a soft pack button battery module 1000 as described in any of the above embodiments. The loudspeaker 2100 is connected to the soft pack button battery module 1000 via a positive lead and a negative lead of the soft pack button battery module 1000.

Compared with the existing art, the sound production apparatus provided in the embodiment of the present application uses a soft pack button battery module 1000 as described in any of the above embodiments, which alleviates interference of the soft pack button battery module 1000 with the loudspeaker 2100, reduces the background noise, and improves the sound production effect of the sound production apparatus 2000.

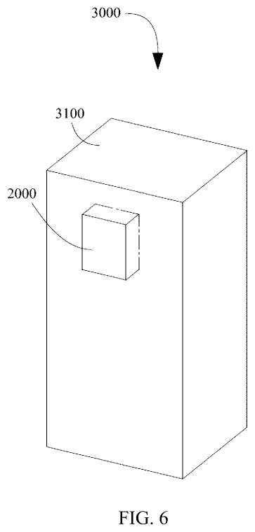

An embodiment of the present application further provides an electronic device 3000 which, as shown in FIG. 6, includes: a device body 3100, and a sound production apparatus 2000 as described in the above embodiment.

Compared with the existing art, the electronic device provided in the embodiment of the present application is characterized in that a sound production apparatus 2000 as described in the above embodiment is disposed on the device body 3100 of the electronic device 3000, which improves the sound production effect of the electronic device 3000.

Optionally, the electronic device 3000 may be wireless earphones, a smart watch, or any other electronic device, which is not specifically limited in the embodiments of the present application.

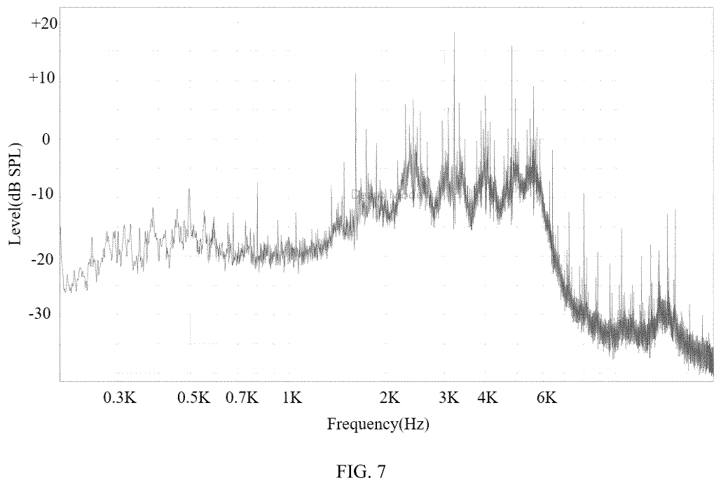

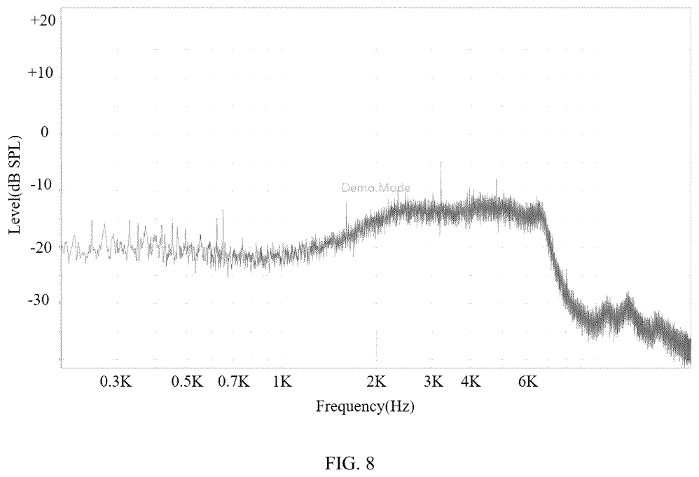

Also referring to FIGS. 7 and 8, illustratively, from testing of conventional wireless earphones and the improved earphones including the soft pack button battery module 1000 according to the foregoing embodiments, it is found that a background noise peak of the conventional earphones is about +18 db SPL, while a background noise peak of the improved earphones using the soft pack button battery module 1000 of the present application is reduced to about −5 dB SPL, having a notable optimization effect.

It is to be further noted that those of ordinary skill in the art will appreciate that numerous technical details are set forth in various embodiments of the present application to provide a better understanding of the present application. However, the technical solutions claimed in the present application can be implemented even without these technical details or based on various changes and modifications based on the foregoing embodiments. The foregoing embodiments are divided for convenience of description, and should not constitute any limitation to the specific implementation of the present application, and the embodiments may be mutually incorporated and referred to without contradiction.

1. A soft pack button battery module, comprising:
a soft pack button battery having a first tab and a second tab arranged opposite to each other;
an arc-shaped conductive sheet connected to the first tab and extending towards the second tab; and
a conductive sheet tab spaced apart from the second tab, wherein the arc-shaped conductive sheet extends from the first tab along a surface of the soft pack button battery to be connected to the conductive sheet tab.

2. The soft pack button battery module of claim 1, wherein the first tab is a positive tab, the second tab is a negative tab, the soft pack button battery is a cylinder with two opposite bottom surfaces, the positive tab and the negative tab are disposed on a side surface of the soft pack button battery, and the arc-shaped conductive sheet extends to the conductive sheet tab by conforming to the side surface of the soft pack button battery.

3. The soft pack button battery module of claim 1, wherein the first tab is a positive tab, the second tab is a negative tab, the soft pack button battery is a cylinder with two opposite bottom surfaces, the positive tab and the negative tab are disposed on a side surface of the soft pack button battery, and the arc-shaped conductive sheet extends to the conductive sheet tab by conforming to either bottom surface of the soft pack button battery.

4. The soft pack button battery module of claim 3, wherein the arc-shaped conductive sheet extends into a circular arc along an edge of the bottom surface, and is bent at an end of the circular arc and extends along the side surface to the conductive sheet tab.

5. The soft pack button battery module of claim 2, wherein the arc-shaped conductive sheet extends into a circular arc of 100° to 250°.

6. The soft pack button battery module of claim 1, wherein the arc-shaped conductive sheet is glued to the surface of the soft pack button battery.

7. The soft pack button battery module of claim 2, wherein the arc-shaped conductive sheet is connected to the positive tab via laser welding.

8. The soft pack button battery module of claim 2, further comprising a positive lead and a negative lead, wherein the positive lead is connected to the conductive sheet tab by electric resistance welding, and the negative lead is connected to the negative tab by electric resistance welding.

9. A sound production apparatus, comprising:
a loudspeaker; and
a soft pack button battery module having a positive lead and a negative lead, wherein the loudspeaker is connected to the soft pack button battery module via a positive lead and a negative lead of the soft pack button battery module, the soft pack button battery module comprising:
a soft pack button battery having a first tab and a second tab arranged opposite to each other;
an arc-shaped conductive sheet connected to the first tab and extending towards the second tab; and
a conductive sheet tab spaced apart from the second tab, wherein the arc-shaped conductive sheet extends from the first tab along a surface of the soft pack button battery to be connected to the conductive sheet tab.

10. An electronic device, comprising:
a device body; and
a sound production apparatus comprising a loudspeaker and a soft pack button battery module having a positive lead and a negative lead, wherein the loudspeaker is connected to the soft pack button battery module via the positive lead and the negative lead, the soft pack button battery module comprising:
a soft pack button battery having a first tab and a second tab arranged opposite to each other;
an arc-shaped conductive sheet connected to the first tab and extending towards the second tab; and
a conductive sheet tab spaced apart from the second tab, wherein the arc-shaped conductive sheet extends from the first tab along a surface of the soft pack button battery to be connected to the conductive sheet tab.

11. The soft pack button battery module of claim 3, wherein the arc-shaped conductive sheet extends into a circular arc of 100° to 250°.

12. The soft pack button battery module of claim 3, wherein the arc-shaped conductive sheet is connected to the positive tab via laser welding.

13. The soft pack button battery module of claim 3, further comprising a positive lead and a negative lead, wherein the positive lead is connected to the conductive sheet tab by electric resistance welding, and the negative lead is connected to the negative tab by electric resistance welding.

14. The sound production apparatus of claim 9, wherein the first tab is a positive tab, the second tab is a negative tab, the soft pack button battery is a cylinder with two opposite bottom surfaces, the positive tab and the negative tab are disposed on a side surface of the soft pack button battery, and the arc-shaped conductive sheet extends to the conductive sheet tab by conforming to the side surface of the soft pack button battery.

15. The sound production apparatus of claim 9, wherein the first tab is a positive tab, the second tab is a negative tab, the soft pack button battery is a cylinder with two opposite bottom surfaces, the positive tab and the negative tab are disposed on a side surface of the soft pack button battery, and the arc-shaped conductive sheet extends to the conductive sheet tab by conforming to either bottom surface of the soft pack button battery.

16. The sound production apparatus of claim 15, wherein the arc-shaped conductive sheet extends into a circular arc along an edge of the bottom surface, and is bent at an end of the circular arc and extends along the side surface to the conductive sheet tab.

17. The sound production apparatus of claim 14, wherein the arc-shaped conductive sheet extends into a circular arc of 100° to 250°.

18. The sound production apparatus of claim 9, wherein the arc-shaped conductive sheet is glued to the surface of the soft pack button battery.

19. The sound production apparatus of claim 14, wherein the arc-shaped conductive sheet is connected to the positive tab via laser welding.

20. The sound production apparatus of claim 14, wherein the positive lead is connected to the conductive sheet tab by electric resistance welding, and the negative lead is connected to the negative tab by electric resistance welding.
